(19) United States
(12) Patent Application Publication
(10) Pub. No.: US 2024/0330051 A1
(43) Pub. Date: Oct. 3, 2024

(54) DEVICE TASK MANAGEMENT IN A DISTRIBUTED SYSTEM

(71) Applicant: Motorola Mobility LLC, Chicago, IL (US)

(72) Inventors: Xiofeng Zhu, Nanjing (CN); Sanjay Dhar, Algonquin, IL (US)

(73) Assignee: Motorola Mobility LLC, Chicago, IL (US)

(21) Appl. No.: 18/473,653

(22) Filed: Sep. 25, 2023

(30) Foreign Application Priority Data
Mar. 28, 2023 (WO) PCT/CN2023/084293

(51) Int. Cl. G06F 9/48; H04L 67/10

(52) U.S. Cl. CPC G06F 9/4893; H04L 67/10

(57) ABSTRACT

In aspects of device task management in a distributed system, the distributed system includes a task-source device, a compute device, and a task-target device. The compute device receives a task processing request to process a task from the task-source device. The compute device implements a task processing manager that obtains a power availability state for each device in the distributed system of the devices. The task processing manager can also obtain a thermal state for each device in the distributed system of the devices. The task processing manager selects, based on the power availability state and/or the thermal state for each device, the task-target device from the distributed system of the devices. The task processing manager then initiates to provide at least a portion of the task to the task-target device for processing by the task-target device.

### RELATED APPLICATION

This application claims priority benefit of Application Number PCT/CN2023/084293 filed 28 Mar. 2023 entitled “Device Task Management in a Distributed System,” the disclosure of which is incorporated by reference herein in its entirety.

### BACKGROUND

A distributed system of devices refers to a computing ecosystem within which a collection of independent, physically-separated, yet wirelessly-connected devices are configured to share resources directed to processing and achieving tasks. In contributing their respective computing resources (e.g., computer processor(s), memory, storage, etc.) towards not only achieving the processing tasks, but also maintaining their overall operation, each device consumes electrical power, such as through a portable source and/or an electrical grid, and accordingly, produces heat in the form of thermal radiation as a by-product of task processing.

### BRIEF DESCRIPTION OF THE DRAWINGS

Implementations of the techniques for device task management in a distributed system are described with reference to the following Figures. The same numbers may be used throughout to reference like features and components shown in the Figures.

FIG. 1 illustrates an example system for device task management in a distributed system in accordance with one or more implementations as described herein.

FIG. 2 further illustrates an example of devices in a distributed system, which supports device task management in a distributed system in accordance with one or more implementations as described herein.

FIG. 3 illustrates an example procedure, which supports device task management in a distributed system in accordance with one or more implementations as described herein.

FIG. 4 illustrates another example procedure, which supports device task management in a distributed system in accordance with one or more implementations as described herein.

FIGS. 5-9 illustrate example methods for device task management in a distributed system in accordance with one or more implementations of the techniques described herein.

FIG. 10 illustrates various components of an example device that can be used to implement the techniques for device task management in a distributed system as described herein.

### DETAILED DESCRIPTION

Implementations of techniques for device task management in a distributed system are implemented as described herein. A distributed system of devices is a computing ecosystem with independent, physically-separated, yet wirelessly-connected devices that share resources directed to processing and achieving tasks. Any task, or processing task, refers to a set of task instructions (e.g., computer-executable instructions) that are processed as one or more task inputs to generate one or more task results. By way of an example, a task can pertain to the decoding of encoded image data, where the encoded image data represents the task input, and an image decoding algorithm represents the set of task instructions configured to process the encoded image data. Further, as a result of processing the encoded image data by the image decoding algorithm, an uncompressed bitmap can be generated that represents the task result.

Further, in contributing respective computing resources (e.g., computer processor(s), memory, storage, etc.) towards not only processing tasks, but also maintaining overall operation, each device in the distributed system consumes electrical power, such as through a portable source and/or an electrical grid, and accordingly, produces heat in the form of thermal radiation as a by-product. In the distributed system of devices, a disruption of task processing may be caused by device low power and/or high heat levels measured in any given device within the distributed system of the devices. In one or more implementations, aspects of the described techniques account for the power availability state and/or a thermal state for each device across the distributed system of the devices to assign task processing and completion of any task (or at least a portion thereof) to a device that is not only operable to perform the task processing, but also having a power availability state and/or thermal state to adequately perform and complete the task processing.

In a distributed system of devices, a compute device can be any type of a compute engine, mobile device, wireless device, computing device, and/or electronic device that wirelessly communicates with other devices, referred to herein as terminal devices. A terminal device in the distributed system can also be any type of a smart device, wearable device, peripheral device, wireless device, computing device, and/or electronic device. In an example implementation, the compute device and terminal devices are battery operated devices that operate collectively to process and achieve processing tasks by load balancing and power management (e.g., power use management). In this type of a distributed system, various power management scenarios can occur. For example, a terminal device (e.g., display device) may be utilized to access an online streaming video through the compute device (e.g., compute engine) via Miracast or a similar operation. The terminal device may have sufficient power availability, either by battery power or connected to an external power source, to display the video content for at least the overall duration of the online streaming video session. However, if the compute device has a low battery, then a user will not be able to watch the video when the compute device runs out of battery power, even though the terminal device has sufficient power availability.

In one or more implementations, the distributed system of devices includes the compute device, and of the terminal devices, a task-source device, and one or more task-target devices. Although generally described throughout as a distributed system of devices that includes the three devices (e.g., a compute device, a task-source device, and a task-target device), the distributed system of the devices can include any number and combination of the different types of terminal devices. In aspects of the described techniques, the compute device implements a task processing manager for load balancing and distributed power management (e.g., power use management) among the various devices in the distributed system. Notably, although battery power is typically not shareable between the various devices in the distributed system, the task processing manager can load balance to reduce the power consumption by shifting processing tasks to other devices that may have more power availability.

In one or more implementations, the task processing manager of the compute device can receive a task processing request from a task-source device to process a task. The task processing manager obtains a power availability state for each device in the distributed system of devices (e.g., the terminal devices), and selects a task-target device based at least in part on the power availability state of the device. The task processing manager can then initiate to provide or communicate to the task-target device at least a portion of the task for processing by the task-target device. In implementations, the power availability state of the task-target device can be an indication that the task-target device is connected for unlimited power, that a battery level of the task-target device exceeds a reference battery level (e.g., has sufficient battery power), or that the task-target device has a power capacity to perform at least the portion of the task for processing.

In further implementations, the task processing manager can also take into account various device information of the terminal devices as the basis from which to select a task-target device for processing at least a portion of an assigned processing task. For example, the task processing manager can also obtain a thermal state for each of the devices in the distributed system of the devices, and the task-target device is selected based at least in part on the thermal state of the task-target device. The thermal state of the task-target device can indicate that a battery temperature and/or a processor temperature is below a reference temperature (e.g., the device is operating at a satisfactory temperature to perform the processing task). The task processing manager can also filter the distributed system of the devices based on task resource requirements of the task to determine a task-target device that has the power and processing capability to perform the task processing.

While features and concepts of the described techniques for device task management in a distributed system can be implemented in any number of different devices, systems, environments, and/or configurations, implementations of the techniques for device task management in a distributed system are described in the context of the following example devices, systems, and methods.

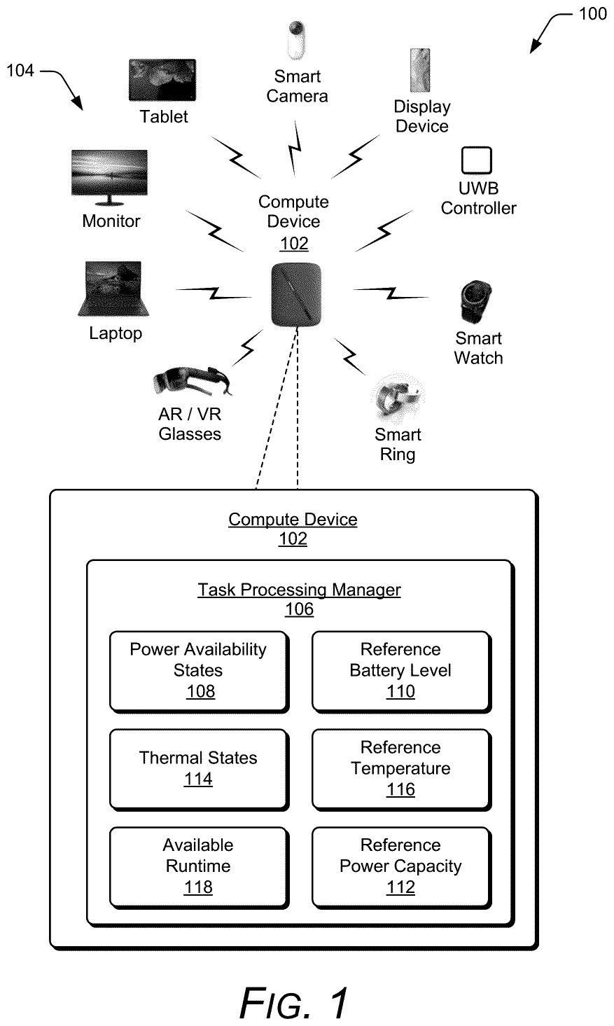

FIG. 1 illustrates an example system 100 for device task management in a distributed system, as described herein. The example system 100 represents a distributed system of devices, which include a compute device 102 and any number of various, different terminal devices 104. The distributed system of devices is a computing ecosystem with independent, physically-separated, yet wirelessly-connected devices that are configured to share resources directed to processing and achieving processing tasks. Any task, or processing task, refers to a set of task instructions (e.g., computer-executable instructions) that are processed as one or more task inputs to generate one or more task results. The compute device 102 can be any type of a compute engine, mobile device, wireless device, computing device, electronic device, and/or any combination thereof. In this example system 100, each of the terminal devices 104 can also be any type of smart device, wearable device, peripheral device, wireless device, computing device, and/or electronic device, such as a smart camera, a display device, a UWB controller, a smart watch, a smart ring, AR/VR glasses, a laptop computer, a monitor device, a tablet computer, etc., and/or any combination thereof.

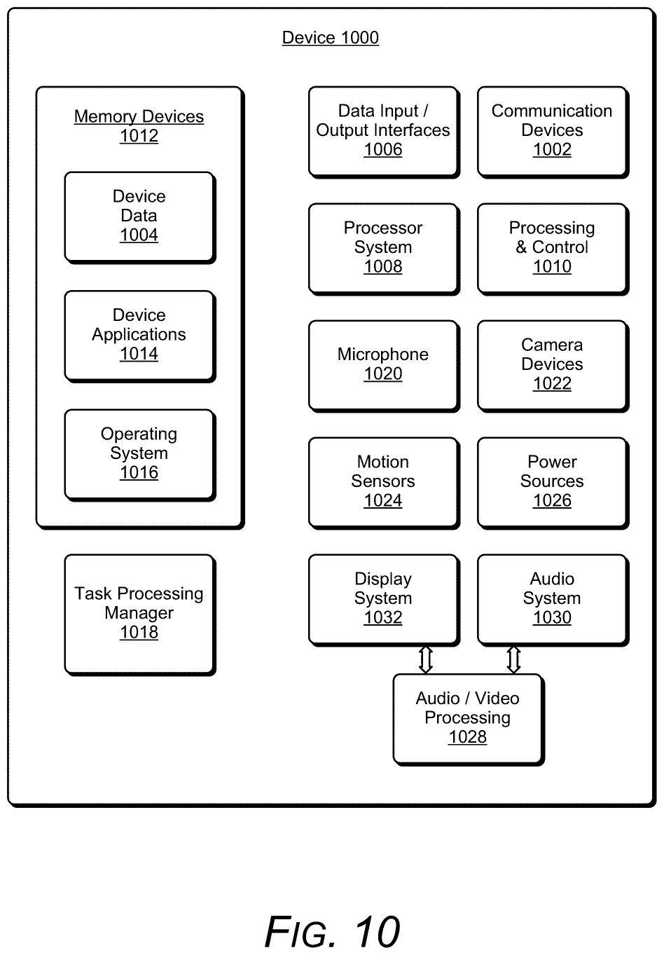

The compute device 102 and/or any of the terminal devices 104 can be implemented with various components, such as a processor system and memory, as well as any number and combination of different components further described with reference to the example device shown in FIG. 10. In implementations, the compute device 102 and/or a terminal device 104 includes various functionalities that enables the compute device 102 and/or terminal device 104 to implement different aspects of device task management in a distributed system, as described herein. In implementations, the compute device 102 and/or a terminal device 104 includes any one or various radios for wireless communication with other devices, such as with any other devices in the distributed system of devices. For example, the compute device 102 and/or a terminal device 104 may include a Bluetooth (BT) and/or Bluetooth Low Energy (BLE) transceiver and/or a near field communication (NFC) transceiver. The compute device 102 and/or a terminal device 104 may also include a Wi-Fi radio, a GPS radio, and/or any type of device communication interfaces. In implementations, the compute device 102 and the terminal devices 104 include a battery and/or any other type of similar power source, such as described with reference to the example device shown in FIG. 10. The battery or similar power source powers the components of the respective devices, such as the communications devices, the processor system, device sensors, and other hardware and circuitry of the devices.

Any of the devices, applications, modules, servers, and/or services described herein can communicate via a communication network, such as for data communication between the compute device 102, terminal devices 104, and other communication and/or computing devices. The communication network can be implemented to include a wired and/or a wireless network, may be implemented using any type of network topology and/or communication protocol, and can be represented or otherwise implemented as a combination of two or more networks, to include IP based networks and/or the Internet. The communication network may also include mobile operator networks that are managed by a mobile network operator and/or other network operators, such as a communication service provider, mobile phone provider, and/or Internet service provider.

Any of the devices in the distributed system, such as the compute device 102 and/or any of the terminal devices 104 can include and implement various device applications, such as any type of messaging application, email application, video communication application, cellular communication application, music application, gaming application, media application, social platform applications, and/or any other of the many possible types of device applications. Many of the device applications have an associated application user interface that is generated and displayed for user interaction and viewing, such as on a display screen of a respective device, or cast or communicated for display on another of the devices. Generally, an application user interface, or any other type of video, image, graphic, and the like is digital image content that is displayable on a display screen of a device.

In this example system 100, the compute device 102 includes a task processing manager 106 that represents functionality (e.g., logic, software, and/or hardware) enabling task management across the distributed system of devices, as well as task processing locally on the compute device 102. The task processing manager 106 can be implemented as computer instructions stored on computer-readable storage media (e.g., memory of the device), or in any other suitable memory device or electronic data storage, and can be executed by a processor of the device, where the processor is implemented at least partially in computer hardware. Alternatively or in addition, the task processing manager 106 can be implemented at least partially in firmware and/or at least partially in computer hardware. For example, at least part of the task processing manager 106 may be executable by a computer processor, and/or at least part of the task processing manager 106 may be implemented in logic circuitry (e.g., hardware). In one or more implementations, the task processing manager 106 can include independent processing, memory, and/or logic components functioning as a computing and/or electronic device integrated with the compute device 102.

In one or more implementations, the task processing manager 106 obtains and/or maintains a power availability state 108 for each of the terminal devices 104 in the distributed system of devices. The task processing manager 106 can also maintain a power availability state 108 for the compute device 102. In implementations, a power availability state 108 can indicate various power-relevant information of a respective device, such as a battery level or a remaining battery power of a device battery, metrics related to battery usage of the device battery, and/or whether the device is being powered by the battery or is plugged-in to an external power source, such as when the device is charging. The task processing manager 106 can obtain and/or maintain a local power availability state 108 of the compute device 102 by interfacing with device sensors, and can obtain and/or maintain any remote power availability state 108 of a terminal device 104 by way of a status protocol (e.g., periodic status messages) established between the compute device 102 and any of the terminal devices.

The compute device 102 and/or any of the terminal devices 104 can include any type of device sensors, such as described with reference to the example device shown in FIG. 10. The device sensors are utilized to monitor device states pertaining to components of a respective device, such as any of the communications devices, processor system, the device battery, and other hardware of the device. In implementations, the device sensors can include temperature sensors to monitor battery and processor temperatures, as well as power sensors to monitor component operation, such as voltages, current, and/or power. In this example, the task processing manager 106 also maintains a reference battery level 110, which may include an indication of the remaining battery power of the compute device battery. Further, the reference battery level 110 can serve as a benchmark against which the battery levels of the other terminal devices 104 in the distributed system of devices may be compared. Similarly, the task processing manager 106 can maintain a reference power capacity 112, which may also be used as a reference comparison to determine whether a terminal device 104 can perform task processing.

The task processing manager 106 can also obtain and/or maintain a thermal state 114 for each of the terminal devices 104 in the distributed system of devices. The task processing manager 106 can also maintain a thermal state 114 for the compute device 102. In implementations, the thermal state 114 of a terminal device 104 (or the compute device 102) can indicate that a battery temperature and/or a processor temperature is below a reference temperature 116 (e.g., the device is operating at a satisfactory temperature). In implementations, a thermal state 114 can indicate various thermal-relevant information of a respective device, such as a battery temperature of a device battery and/or a processor temperature of a processor system of the device. The task processing manager 106 can obtain and/or maintain a local thermal state 114 of the compute device 102 by interfacing with device sensors, and can obtain and/or maintain any remote thermal state 114 a terminal device 104 by way of a status protocol (e.g., periodic status messages) established between the compute device 102 and any of the terminal devices. In this example, the task processing manager 106 maintains the reference temperature 116.

In one or more implementations, the task processing manager 106 can also obtain and/or maintain an available runtime 118 for each of the terminal devices 104 in the distributed system of devices. The task processing manager 106 can also maintain an available runtime 118 of the compute device 102. In implementations, the available runtime 118 of a terminal device 104 (or the compute device 102) can be an indication of a remaining operational time of a respective device, such as derived from a combination of remaining device battery power level and a computational load executing on the device. Further, the available runtime 118 may serve as a benchmark against which the remaining runtime of other terminal devices 104 in the distributed system of devices may be compared.

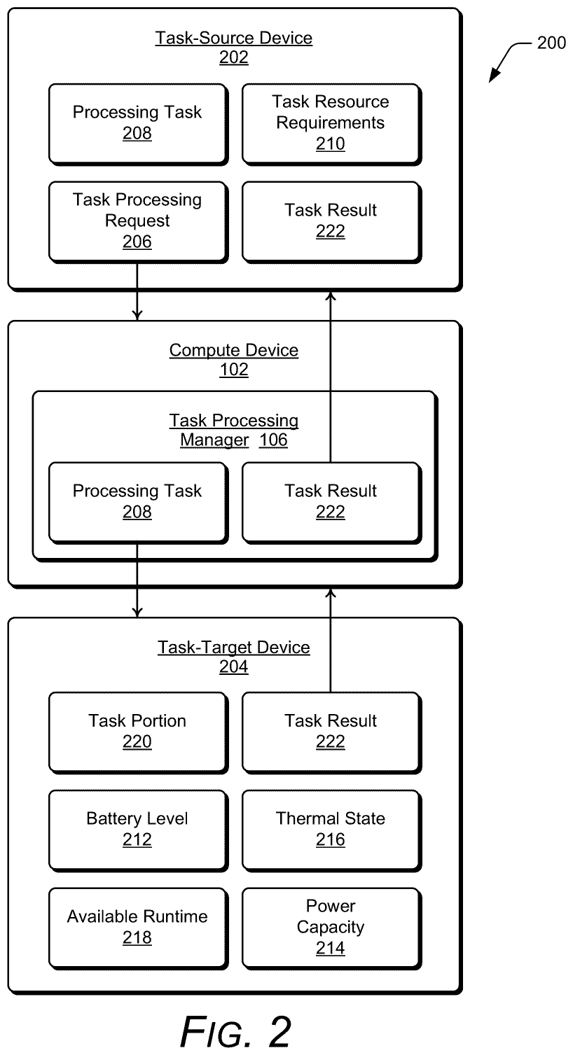

FIG. 2 further illustrates an example 200 of the devices shown and described with reference to FIG. 1 for device task management in a distributed system, as described herein. This example 200 includes the compute device 102, as well as examples of the terminal devices 104, notably a task-source device 202 and a task-target device 204. In one or more implementations, the task processing manager 106 of the compute device 102 receives a task processing request 206 from the task-source device 202 to process a task 208 (e.g., the processing task 208 shown at both the task-source device 202 and received at the compute device 102).

In implementations, the task-source device 202 may also provide task resource requirements 210 to the compute device 102 along with the task processing request 206 to process the task 208. The task resource requirements 210 for any given task can include a specified minimum of one or more computational resources needed to successfully process the given task. Examples of the task resource requirements include a minimum operating system family and/or version, an instruction set architecture, a minimum processor system (e.g., central processing unit (CPU) and/or graphics processing unit (GPU)) and relatable clock speed, a minimum processor system dedicated memory (e.g., random access memory (RAM) for a CPU, video memory for a GPU, etc.), and a minimum free persistent and/or non-persistent storage space.

As described above, the task processing manager 106 of the compute device obtains the power availability state 108 for each of the terminal devices 104 in the distributed system of devices. For example, the task-target device 204 (e.g., a terminal device 104) provides a battery level 212 of the device battery and/or provides a power capacity 214 of the task-target device 204 to the task processing manager 106 of the compute device. In implementations, the power availability state of the task-target device 204 can be an indication that the task-target device is connected for unlimited power, that a battery level of the task-target device exceeds the reference battery level 110 (e.g., has sufficient battery power), and/or that the task-target device has the power capacity 214 to perform at least a portion of the task processing. In implementations, the task processing manager 106 can also obtain the thermal state 114 for each of the terminal devices 104 in the distributed system of devices. For example, the task-target device 204 provides a thermal state 216 of the task-target device 204 to the task processing manager 106 of the compute device. In one or more implementations, the task processing manager 106 can also obtain the available runtime 118 for each of the terminal devices 104 in the distributed system of devices. For example, the task-target device 204 provides an available runtime 218 of the task-target device to the task processing manager 106 of the compute device.

In aspects of the described techniques, the task processing manager 106 receives the task processing request 206 from the task-source device 202 to process the task 208, and selects the task-target device 204 based at least in part on the power availability state 108 of the device. The task processing manager 106 can then initiate to provide or communicate to the task-target device 204 at least a task portion 220 of the task 208 for processing by the task-target device. Additionally, the task processing manager 106 can also take into account various device information of the task-target device 204 as the basis from which to select the task-target device for processing at least the task portion 220 of the processing task 208. For example, the task-target device 204 may also be selected based on the thermal state 216 of the task-target device. The task processing manager 106 can also filter the distributed system of the devices based on the task resource requirements 210 of the processing task 208 to determine that the task-target device 204 has the power and processing capability to perform the task processing.

In one or more implementations, the task processing manager 106 of the compute device 102 receives back a task result 222 from the task-target device 204 (e.g., the task result 222 shown at both the task-target device 204 and received at the compute device 102). The task processing manager 106 can then provide the task result 222 to the task-source device. Similarly, the task processing manager 106 of the compute device 102 receives a first task result from the task-target device 204 that processes the task portion 220 of the processing task 208. The task processing manager 106 can then process a remainder portion of the processing task 208 to produce a second task result, and providing the first task result and the second task result to the task-source device 202 as the complete task result 222.

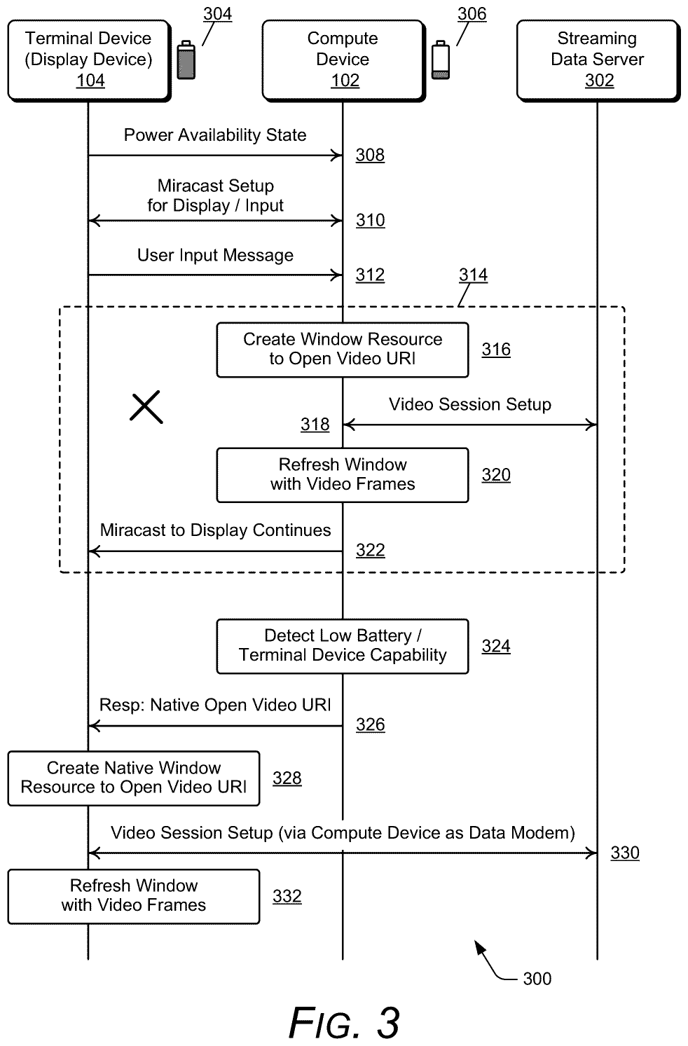

FIG. 3 illustrates an example procedure 300 for device task management in a distributed system, as described herein. This example procedure 300 includes the compute device 102 and a terminal device 104 (e.g., a display device), as well as communication with a streaming data server 302 for online streaming of video content through the compute device. In this example, the terminal device 104 has a charged battery 304 with sufficient power capacity to display the streaming video content, whereas the compute device 102 has a low battery 306 that will not sustain the streaming video operation for the duration of the session. The task processing manager 106 of the compute device 102 receives or obtains the power availability state 108 of the terminal device 104 from the terminal device (at 308). The compute device 102 and the terminal device 104 setup a Miracast session for input and display of the streaming video content on the display device (at 310), and the terminal device communicates a user input message back to the compute device to begin streaming the video content for display (at 312).

In a typical procedure, the compute device 102 would then handle the user input message (received at 312), open the video link, decode it, and present frames through the Miracast session to the terminal display, as generally indicated at 314. For example, the compute device 102 creates a window resource to open a video (URI) (at 316), and establishes to setup the video session with the streaming data server 302 (at 318). The compute device 102 then refreshes the window with video frames (at 320) and the Miracast session to the display device continues (at 322). In this typical example, the terminal device 104 has sufficient power availability with the charged battery 304 to display the video content for at least the overall duration of the online streaming video session. However, given that the compute device 102 has a low battery 306, the user will not be able to watch the video when the compute device 102 runs out of battery power, even though the terminal device has sufficient power availability.

Therefore, rather than the typical procedure generally indicated at 314, and in aspects of the techniques described herein for device task management in a distributed system, the task processing manager 106 of the compute device 102 provides for alternate task processing by load balancing and power use management. The compute device 102 notifies the terminal device 104 to access the video link, decode the video, and render the content directly for display utilizing its own processor and battery power. For example, the task processing manager 106 detects the low battery state of the compute device 102, as well as the power availability state 108 and/or power capacity 214 of the terminal device 104 (at 324). The compute device 102 communicates a response for native open video URI to the terminal device (at 326), and the terminal device 104 creates the native window resource to open the video URI (at 328). The video session is then setup between the terminal device 104 and the streaming data server 302 via the compute device 102, which is used only as a data modem for communication between the terminal device and the data server (at 330). The terminal device 104 can then refresh the window with the video frames (at 332).

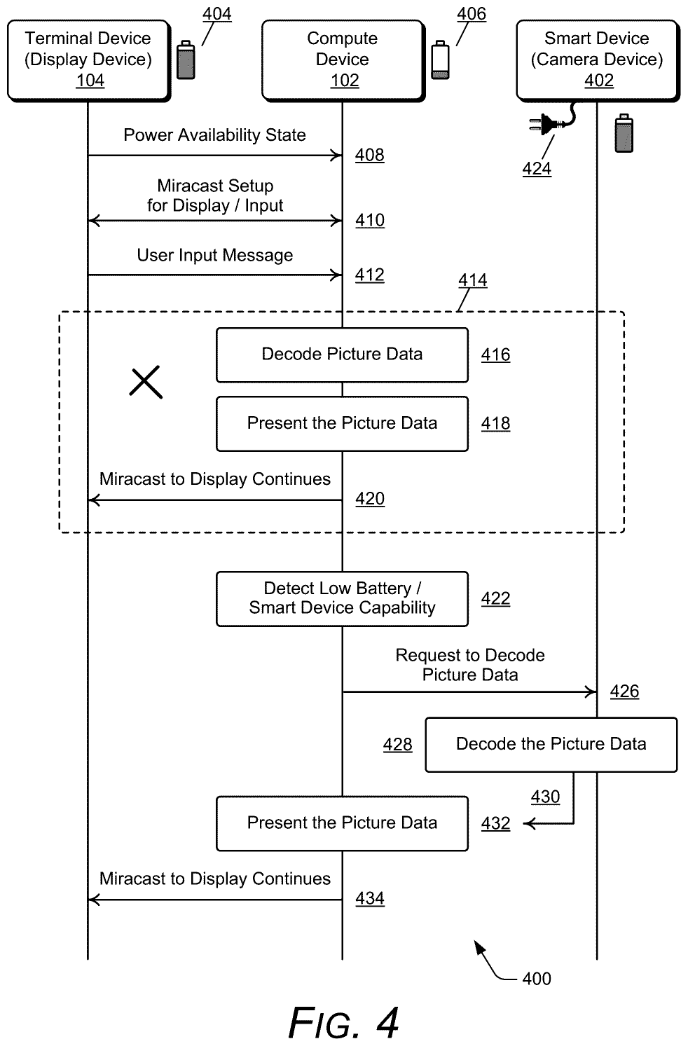

FIG. 4 illustrates an example procedure 400 for device task management in a distributed system, as described herein. This example procedure 400 includes the compute device 102 and a terminal device 104 (e.g., a display device), as well as utilizing a smart device 402 (e.g., a camera device) in the distributed system of the devices to review pictures (e.g., picture thumbnails and/or picture details). In this example, the terminal device 104 has a charged battery 404 with sufficient power capacity to display the picture content, whereas the compute device 102 has a low battery 406 that will not sustain the picture viewing operation. The task processing manager 106 of the compute device 102 receives or obtains the power availability state 108 of the terminal device 104 from the terminal device (at 408). The compute device 102 and the terminal device 104 setup a Miracast session for input and display of the picture content on the display device (at 410), and the terminal device communicates a user input message back to the compute device to begin the picture content for display (at 412).

In a typical procedure, the compute device 102 would then handle the user input message (received at 412), open the picture file, decode it, and present the picture images through the Miracast session to the terminal display, as generally indicated at 414. For example, the compute device 102 decodes the picture data (at 416), presents the picture data (at 418), and continues the Miracast session to the display device (at 420). In this typical example, the terminal device 104 has sufficient power availability with the charged battery 404 to display the picture content for at least the overall duration of the Miracast session. However, given that the compute device 102 has a low battery 406, the user will not be able to view the pictures when the compute device 102 runs out of battery power, even though the terminal device has sufficient power availability.

Therefore, rather than the typical procedure generally indicated at 414, and in aspects of the techniques described herein for device task management in a distributed system, the task processing manager 106 of the compute device 102 provides for alternate task processing by load balancing and power use management. For example, the task processing manager 106 detects the low battery state of the compute device 102, as well as a power availability state 108 and/or power capacity 214 of the smart device 402 (at 422), noting that the smart device 402 has a charged battery and is plugged-in for a power source 424. The compute device 102 communicates a request to decode the picture data to the powered smart device 402 (at 426), and the smart device 402 decodes the picture data (at 428) which is communicated back to the compute device 102 (at 430). In implementations, the picture data can be shared between devices by way of a net drive or other similar technique. The compute device 102 presents the picture data (at 432), and continues the Miracast session to the display device (at 434).

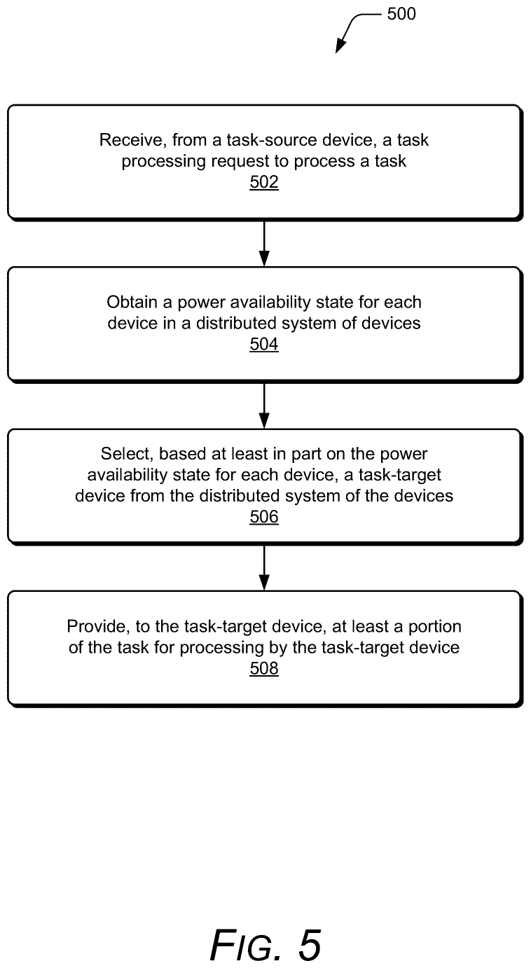

Example methods 500, 600, 700, 800, and 900 are described with reference to respective FIGS. 5-9 in accordance with one or more implementations for device task management in a distributed system, as described herein. Generally, any services, components, modules, managers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 for device task management in a distributed system. The order in which the method is described is not intended to be construed as a limitation, and any number or combination of the described method operations can be performed in any order to perform a method, or an alternate method.

At 502, a task processing request to process a task is received from a task-source device. For example, the task processing manager 106 of the compute device 102 receives a task processing request 206 to process a task 208 from the task-source device 202 in the distributed system of the devices (e.g., example system 100 as shown and described with reference to FIG. 1).

At 504, a power availability state is obtained for each device in a distributed system of devices. For example, the task processing manager 106 obtains a power availability state 108 for each of the terminal devices 104 in the distributed system of devices. The task processing manager 106 can also maintain a power availability state 108 for the compute device 102. In implementations, a power availability state 108 can indicate various power-relevant information of a respective device, such as a battery level or a remaining battery power of a device battery, metrics related to battery usage of the device battery, and/or whether the device is being powered by the battery or is plugged-in to an external power source, such as when the device is charging. In implementations, the power availability state 108 of the task-target device 204 indicates that the task-target device is connected for unlimited power, that the battery level 212 of the task-target device exceeds the reference battery level 110, and/or that the task-target device has the power capacity 214 to perform at least the task portion 220 of the processing task 208 received from the task-source device 202 via the compute device 102.

At 506, a task-target device is selected from the distributed system of the devices based at least in part on the power availability state for each device. For example, the task processing manager 106 selects the task-target device 204 based at least in part on the power availability state 108 of the device and/or based on the power capacity 214 of the device. At 508, at least a portion of the task is provided to the task-target device for processing. For example, the task processing manager 106 initiates to provide or communicate to the task-target device 204 at least a task portion 220 of the task 208 for processing by the task-target device.

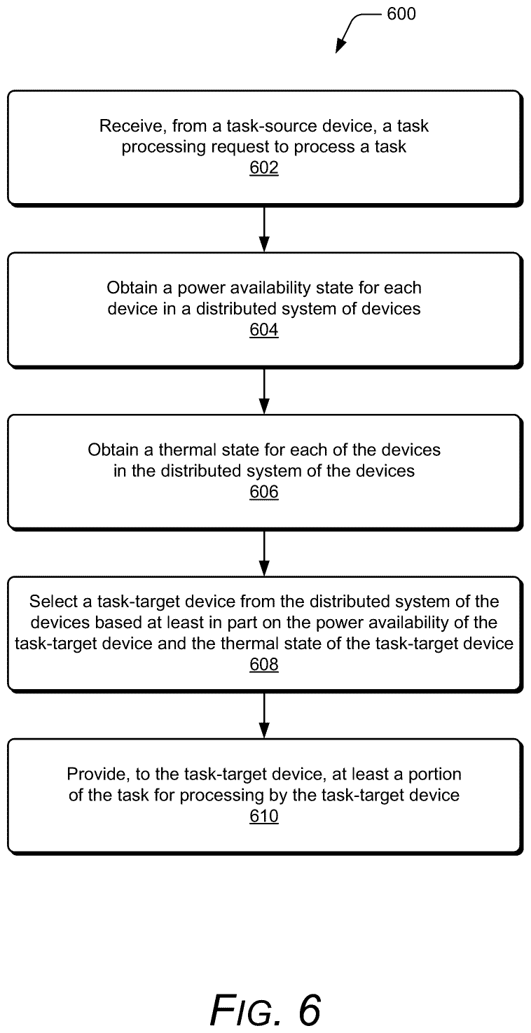

FIG. 6 illustrates example method(s) 600 for device task management in a distributed system. The order in which the method is described is not intended to be construed as a limitation, and any number or combination of the described method operations can be performed in any order to perform a method, or an alternate method.

At 602, a task processing request to process a task is received from a task-source device. For example, the task processing manager 106 of the compute device 102 receives a task processing request 206 to process a task 208 from the task-source device 202 in the distributed system of the devices (e.g., example system 100 as shown and described with reference to FIG. 1).

At 604, a power availability state is obtained for each device in a distributed system of devices. For example, the task processing manager 106 obtains a power availability state 108 for each of the terminal devices 104 in the distributed system of devices. The task processing manager 106 can also maintain a power availability state 108 for the compute device 102. In implementations, the power availability state 108 of the task-target device 204 indicates that the task-target device is connected for unlimited power, that the battery level 212 of the task-target device exceeds the reference battery level 110, and/or that the task-target device has the power capacity 214 to perform at least the task portion 220 of the processing task 208 received from the task-source device 202 via the compute device 102.

At 606, a thermal state is obtained for each of the devices in the distributed system of the devices. For example, the task processing manager 106 obtains the thermal state 114 for each of the terminal devices 104 in the distributed system of devices. The task processing manager 106 can also maintain a thermal state 114 for the compute device 102. In implementations, the thermal state 114 of a terminal device 104 (e.g., the task-target device 204 and/or the compute device 102) can indicate that a battery temperature and/or a processor temperature is below the reference temperature 116 (e.g., the device is operating at a satisfactory temperature). In implementations, a thermal state 114 can indicate various thermal-relevant information of a respective device, such as a battery temperature of a device battery and/or a processor temperature of a processor system of the device.

At 608, a task-target device is selected from the distributed system of the devices based at least in part on the power availability of the task-target device and the thermal state of the task-target device. For example, the task processing manager 106 selects the task-target device 204 based at least in part on the power availability state 108 of the device and/or based on the thermal state 216 of the task-target device. In implementations, the task processing manager 106 can select the task-target device 204 by taking into account any of various device information as the basis from which to select the task-target device for processing at least the task portion 220 of the processing task 208.

At 610, at least a portion of the task is provided to the task-target device for processing. For example, the task processing manager 106 initiates to provide or communicate to the task-target device 204 at least the task portion 220 of the processing task 208 for processing by the task-target device.

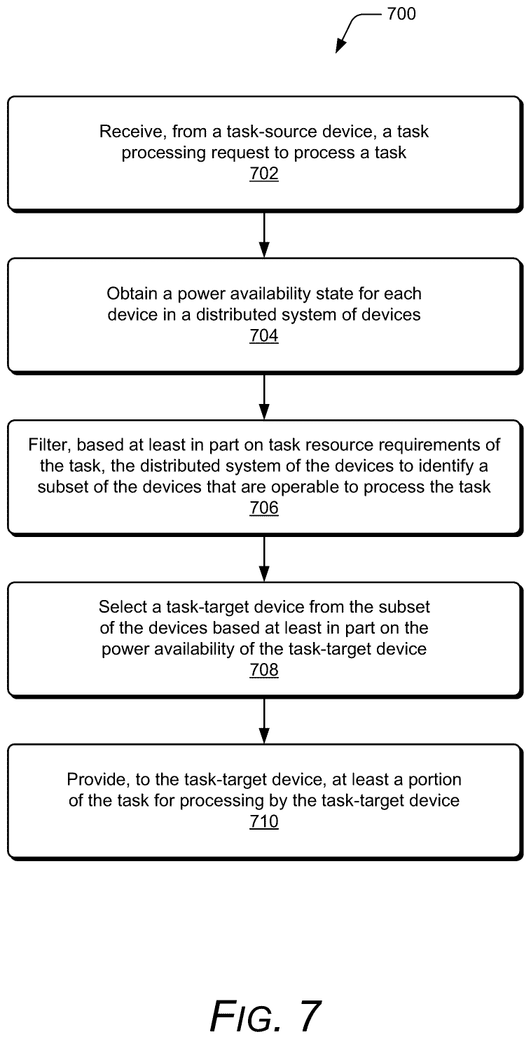

FIG. 7 illustrates example method(s) 700 for device task management in a distributed system. The order in which the method is described is not intended to be construed as a limitation, and any number or combination of the described method operations can be performed in any order to perform a method, or an alternate method.

At 702, a task processing request to process a task is received from a task-source device. For example, the task processing manager 106 of the compute device 102 receives a task processing request 206 to process a task 208 from the task-source device 202 in the distributed system of the devices (e.g., example system 100 as shown and described with reference to FIG. 1).

At 704, a power availability state is obtained for each device in a distributed system of devices. For example, the task processing manager 106 obtains a power availability state 108 for each of the terminal devices 104 in the distributed system of devices. The task processing manager 106 can also maintain a power availability state 108 for the compute device 102. In implementations, the power availability state 108 of the task-target device 204 indicates that the task-target device is connected for unlimited power, that the battery level 212 of the task-target device exceeds the reference battery level 110, and/or that the task-target device has the power capacity 214 to perform at least the task portion 220 of the processing task 208 received from the task-source device 202 via the compute device 102.

At 706, the distributed system of the devices is filtered, based at least in part on task resource requirements of the task, to identify a subset of the devices that are operable to process the task. For example, the task processing manager 106 filters the distributed system of the devices based on the task resource requirements 210 of the processing task 208 to determine that the task-target device 204 has the power and processing capability to perform the task processing.

At 708, a task-target device is selected from the subset of the devices based at least in part on the power availability of the task-target device. For example, the task processing manager 106 selects the task-target device 204 from the subset of the devices that are determined operable to process the task (at 706) based at least in part on the power availability state 108 of the device and/or based on the power capacity 214 of the device. At 710, at least a portion of the task is provided to the task-target device for processing. For example, the task processing manager 106 initiates to provide or communicate to the task-target device 204 at least a task portion 220 of the task 208 for processing by the task-target device.

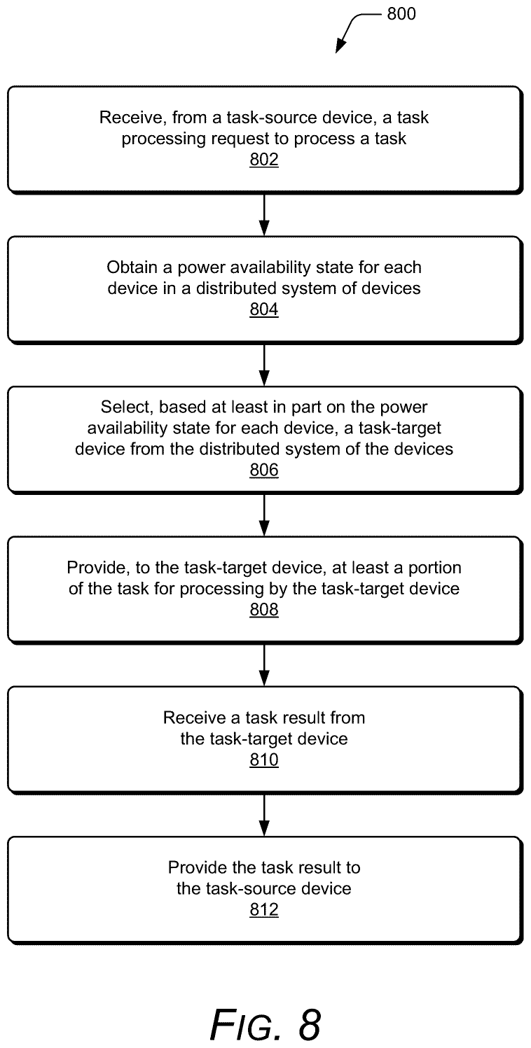

FIG. 8 illustrates example method(s) 800 for device task management in a distributed system. The order in which the method is described is not intended to be construed as a limitation, and any number or combination of the described method operations can be performed in any order to perform a method, or an alternate method.

At 802, a task processing request to process a task is received from a task-source device. For example, the task processing manager 106 of the compute device 102 receives a task processing request 206 to process a task 208 from the task-source device 202 in the distributed system of the devices (e.g., example system 100 as shown and described with reference to FIG. 1).

At 804, a power availability state is obtained for each device in a distributed system of devices. For example, the task processing manager 106 obtains a power availability state 108 for each of the terminal devices 104 in the distributed system of devices. The task processing manager 106 can also maintain a power availability state 108 for the compute device 102. In implementations, the power availability state 108 of the task-target device 204 indicates that the task-target device is connected for unlimited power, that the battery level 212 of the task-target device exceeds the reference battery level 110, and/or that the task-target device has the power capacity 214 to perform at least the task portion 220 of the processing task 208 received from the task-source device 202 via the compute device 102.

At 806, a task-target device is selected from the distributed system of the devices based at least in part on the power availability state for each device. For example, the task processing manager 106 selects the task-target device 204 based at least in part on the power availability state 108 of the device and/or based on the power capacity 214 of the device. At 808, at least a portion of the task is provided to the task-target device for processing. For example, the task processing manager 106 initiates to provide or communicate to the task-target device 204 at least a task portion 220 of the task 208 for processing by the task-target device.

At 810, a task result is received from the task-target device. For example, the task processing manager 106 of the compute device 102 receives back the task result 222 from the task-target device 204. At 812, the task result is provided to the task-source device. For example, the task processing manager 106 then provides the task result 222 to the task-source device 202.

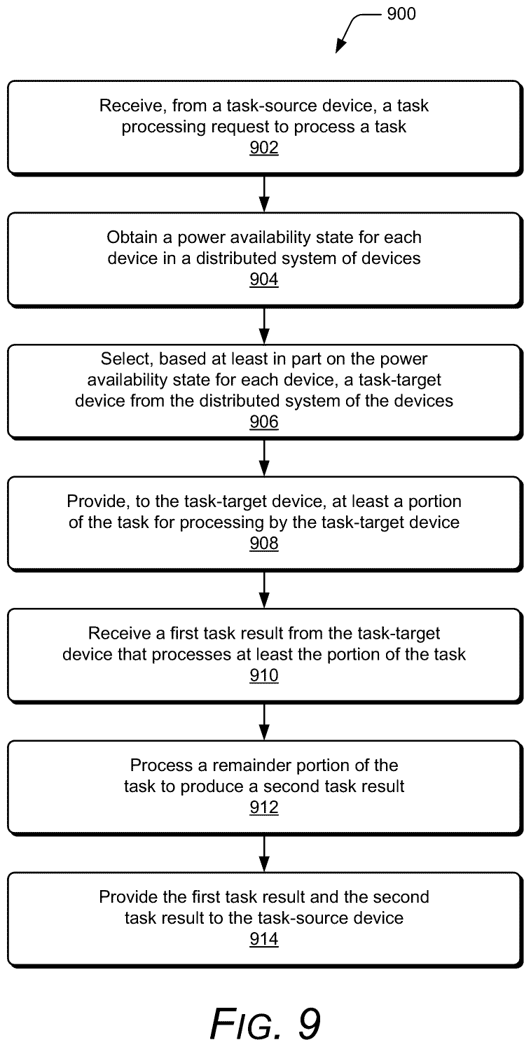

FIG. 9 illustrates example method(s) 900 for device task management in a distributed system. The order in which the method is described is not intended to be construed as a limitation, and any number or combination of the described method operations can be performed in any order to perform a method, or an alternate method.

At 902, a task processing request to process a task is received from a task-source device. For example, the task processing manager 106 of the compute device 102 receives a task processing request 206 to process a task 208 from the task-source device 202 in the distributed system of the devices (e.g., example system 100 as shown and described with reference to FIG. 1).

At 904, a power availability state is obtained for each device in a distributed system of devices. For example, the task processing manager 106 obtains a power availability state 108 for each of the terminal devices 104 in the distributed system of devices. The task processing manager 106 can also maintain a power availability state 108 for the compute device 102. In implementations, the power availability state 108 of the task-target device 204 indicates that the task-target device is connected for unlimited power, that the battery level 212 of the task-target device exceeds the reference battery level 110, and/or that the task-target device has the power capacity 214 to perform at least the task portion 220 of the processing task 208 received from the task-source device 202 via the compute device 102.

At 906, a task-target device is selected from the distributed system of the devices based at least in part on the power availability state for each device. For example, the task processing manager 106 selects the task-target device 204 based at least in part on the power availability state 108 of the device and/or based on the power capacity 214 of the device. At 908, at least a portion of the task is provided to the task-target device for processing. For example, the task processing manager 106 initiates to provide or communicate to the task-target device 204 at least a task portion 220 of the task 208 for processing by the task-target device.

At 910, a first task result is received from the task-target device that processes at least the portion of the task. For example, the task processing manager 106 of the compute device 102 receives a first task result from the task-target device 204 that processes the task portion 220 of the processing task 208. At 912, a remainder portion of the task is processed to produce a second task result. For example, the task processing manager 106 can then process a remainder portion of the processing task 208 to produce a second task result. At 914, the first task result and the second task result are provided to the task-source device. For example, the task processing manager 106 provides the first task result and the second task result to the task-source device 202 as the complete task result 222.

FIG. 10 illustrates various components of an example device 1000, which can implement aspects of the techniques and features for device task management in a distributed system, as described herein. The example device 1000 can be implemented as any of the devices described with reference to the previous FIGS. 1-9, such as any type of a compute device, terminal device, wearable device, peripheral device, wireless device, mobile device, mobile phone, flip phone, client device, companion device, paired device, display device, tablet, computing, communication, entertainment, gaming, media playback, and/or any other type of computing and/or electronic device. For example, the compute device 102 and/or a terminal device 104 described with reference to FIGS. 1-9 may be implemented as the example device 1000.

The example device 1000 can include various, different communication devices 1002 that enable wired and/or wireless communication of device data 1004 with other devices. The device data 1004 can include any of the various devices data and content that is generated, processed, determined, received, stored, and/or communicated from one computing device to another. Generally, the device data 1004 can include any form of audio, video, image, graphics, and/or electronic data that is generated by applications executing on a device. The communication devices 1002 can also include transceivers for cellular phone communication and/or for any type of network data communication.

The example device 1000 can also include various, different types of data input/output (I/O) interfaces 1006, such as data network interfaces that provide connection and/or communication links between the devices, data networks, and other devices. The I/O interfaces 1006 can be used to couple the device to any type of components, peripherals, and/or accessory devices, such as a computer input device that may be integrated with the example device 1000. The I/O interfaces 1006 may also include data input ports via which any type of data, information, media content, communications, messages, and/or inputs can be received, such as user inputs to the device, as well as any type of audio, video, image, graphics, and/or electronic data received from any content and/or data source.

The example device 1000 includes a processor system 1008 of one or more processors (e.g., any of microprocessors, controllers, and the like) and/or a processor and memory system implemented as a system-on-chip (SoC) that processes computer-executable instructions. The processor system 1008 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 1010. The example device 1000 may also include any type of a system bus or other data and command transfer system that couples the various components within the device. A system bus can include any one or combination of different bus structures and architectures, as well as control and data lines.

The example device 1000 also includes memory and/or memory devices 1012 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 1012 include volatile memory and non-volatile memory, fixed and removable media devices, and any suitable memory device or electronic data storage that maintains data for computing device access. The memory devices 1012 can include various implementations of random-access memory (RAM), read-only memory (ROM), flash memory, and other types of storage media in various memory device configurations. The example device 1000 may also include a mass storage media device.

The memory devices 1012 (e.g., as computer-readable storage memory) provide data storage mechanisms, such as to store the device data 1004, other types of information and/or electronic data, and various device applications 1014 (e.g., software applications and/or modules). For example, an operating system 1016 can be maintained as software instructions with a memory device 1012 and executed by the processor system 1008 as a software application. The device applications 1014 may also include a device manager, such as any form of a control application, software application, signal-processing and control module, code that is specific to a particular device, a hardware abstraction layer for a particular device, and so on.

In this example, the device 1000 includes a task processing manager 1018 that implements various aspects of the described features and techniques described herein. The task processing manager 1018 can be implemented with hardware components and/or in software as one of the device applications 1014, such as when the example device 1000 is implemented as the compute device 102 and/or as a terminal device 104 as described with reference to FIGS. 1-9. An example of the task processing manager 1018 is the task processing manager 106 implemented in the compute device 102, such as a software application and/or as hardware components in the wireless device. In implementations, the task processing manager 1018 may include independent processing, memory, and logic components as a computing and/or electronic device integrated with the example device 1000.

The example device 1000 can also include a microphone 1020 and/or camera devices 1022, as well as device sensors 1024, including temperature sensors, power sensors, battery sensors, proximity sensors, and/or motion sensors, such as may be implemented as components of an inertial measurement unit (IMU). The device sensors 1024 can be implemented with various motion sensors, such as a gyroscope, an accelerometer, and/or other types of motion sensors to sense motion of the device. The motion sensors can generate sensor data vectors having three-dimensional parameters (e.g., rotational vectors in x, y, and z-axis coordinates) indicating location, position, acceleration, rotational speed, and/or orientation of the device. The example device 1000 can also include one or more power sources 1026, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 1000 can also include an audio and/or video processing system 1028 that generates audio data for an audio system 1030 and/or generates display data for a display system 1032. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 1000. Alternatively, the audio system and/or the display system are external, peripheral components to the example device.

Although implementations of device task management in a distributed system have been described in language specific to features and/or methods, the appended claims are not necessarily limited to the specific features or methods described. Rather, the specific features and methods are disclosed as example implementations of device task management in a distributed system, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A method, comprising: receiving, from a task-source device, a task processing request to process a task; obtaining a power availability state for each device in a distributed system of devices; selecting, based at least in part on the power availability state for each device, a task-target device from the distributed system of the devices; and providing, to the task-target device, at least a portion of the task for processing by the task-target device.

Alternatively or in addition to the above described method, any one or combination of: the power availability state of the task-target device indicates that the task-target device is connected for unlimited power. The power availability state of the task-target device indicates that a battery level of the task-target device exceeds a reference battery level. The power availability state of the task-target device indicates that the task-target device has a power capacity to perform at least the portion of the task for the processing. The method further comprising obtaining a thermal state for each of the devices in the distributed system of the devices, and the task-target device is selected based at least in part on the thermal state of the task-target device. The thermal state of the task-target device indicates that at least one of a battery temperature or a processor temperature is below a reference temperature. The method further comprising filtering, based at least in part on task resource requirements of the task, the distributed system of the devices to identify a subset of the devices that are operable to process the task, and the task-target device is selected from the subset of the devices. The method further comprising receiving a task result from the task-target device; and providing the task result to the task-source device. The method further comprising receiving a first task result from the task-target device that processes at least the portion of the task; processing a remainder portion of the task to produce a second task result; and providing the first task result and the second task result to the task-source device.

A compute device, comprising: a processor implemented at least partially in hardware; and a task processing manager implemented at least partially by the processor and configured to cause the compute device to: receive a task processing request to process a task; obtain a power availability state for each device in a distributed system of devices; select, based at least in part on the power availability state for each device, a task-target device from the distributed system of the devices; and provide, to the task-target device, at least a portion of the task for processing by the task-target device.

Alternatively or in addition to the above described compute device, any one or combination of: the power availability state of the task-target device indicates that the task-target device is connected for unlimited power. The power availability state of the task-target device indicates that a battery level of the task-target device exceeds a reference battery level. The power availability state of the task-target device indicates that the task-target device has a power capacity to perform at least the portion of the task for the processing. The task processing manager is configured to cause the compute device to obtain a thermal state for each of the devices in the distributed system of the devices, and the task-target device is based at least in part on the thermal state of the task-target device. The thermal state of the task-target device indicates that at least one of a battery temperature or a processor temperature is below a reference temperature. The task processing manager is configured to cause the compute device to filter, based at least in part on task resource requirements of the task, the distributed system of the devices to identify a subset of the devices that are operable to process the task, and the task-target device is selected from the subset of the devices. The task processing manager is configured to cause the compute device to receive a task result from the task-target device; and provide the task result to a task-source device. The task processing manager is configured to cause the compute device to receive a first task result from the task-target device that processes at least the portion of the task; process a remainder portion of the task to produce a second task result; and provide the first task result and the second task result to a task-source device.

A distributed system of devices, comprising: a task-source device to generate a task processing request to process a task; a task-target device to process at least a portion of the task; and a compute device to: receive, from the task-source device, the task processing request to process the task; obtain a power availability state for each device in the distributed system of the devices; obtain a thermal state for each of the devices in the distributed system of the devices; select, based on at least one of the power availability state or the thermal state for each device, the task-target device from the distributed system of the devices; and provide, to the task-target device, at least the portion of the task for processing by the task-target device.

Alternatively or in addition to the above described distributed system of the devices, the compute device is configured to receive a task result from the task-target device, and provide the task result to the task-source device.

1. A method, comprising:
receiving, from a task-source device, a task processing request to process a task;
obtaining a power availability state for each device in a distributed system of devices;
selecting, based at least in part on the power availability state for each device, a task-target device from the distributed system of the devices; and
providing, to the task-target device, at least a portion of the task for processing by the task-target device.

2. The method of claim 1, wherein the power availability state of the task-target device indicates that the task-target device is connected for unlimited power.

3. The method of claim 1, wherein the power availability state of the task-target device indicates that a battery level of the task-target device exceeds a reference battery level.

4. The method of claim 1, wherein the power availability state of the task-target device indicates that the task-target device has a power capacity to perform at least the portion of the task for the processing.

5. The method of claim 1, further comprising:
obtaining a thermal state for each of the devices in the distributed system of the devices, and the task-target device is selected based at least in part on the thermal state of the task-target device.

6. The method of claim 5, wherein the thermal state of the task-target device indicates that at least one of a battery temperature or a processor temperature is below a reference temperature.

7. The method of claim 1, further comprising:
filtering, based at least in part on task resource requirements of the task, the distributed system of the devices to identify a subset of the devices that are operable to process the task, and the task-target device is selected from the subset of the devices.

8. The method of claim 1, further comprising:
receiving a task result from the task-target device; and
providing the task result to the task-source device.

9. The method of claim 1, further comprising:
receiving a first task result from the task-target device that processes at least the portion of the task;
processing a remainder portion of the task to produce a second task result; and
providing the first task result and the second task result to the task-source device.

10. A compute device, comprising:
a processor implemented at least partially in hardware; and
a task processing manager implemented at least partially by the processor and configured to cause the compute device to:
receive a task processing request to process a task;
obtain a power availability state for each device in a distributed system of devices;
select, based at least in part on the power availability state for each device, a task-target device from the distributed system of the devices; and
provide, to the task-target device, at least a portion of the task for processing by the task-target device.

11. The compute device of claim 10, wherein the power availability state of the task-target device indicates that the task-target device is connected for unlimited power.

12. The compute device of claim 10,
wherein the power availability state of the task-target device indicates that a battery level of the task-target device exceeds a reference battery level.

13. The compute device of claim 10, wherein the power availability state of the task-target device indicates that the task-target device has a power capacity to perform at least the portion of the task for the processing.

14. The compute device of claim 10, wherein the task processing manager is configured to cause the compute device to obtain a thermal state for each of the devices in the distributed system of the devices, and the task-target device is based at least in part on the thermal state of the task-target device.

15. The compute device of claim 14, wherein the thermal state of the task-target device indicates that at least one of a battery temperature or a processor temperature is below a reference temperature.

16. The compute device of claim 10, wherein the task processing manager is configured to cause the compute device to filter, based at least in part on task resource requirements of the task, the distributed system of the devices to identify a subset of the devices that are operable to process the task, and the task-target device is selected from the subset of the devices.

17. The compute device of claim 10, wherein the task processing manager is configured to cause the compute device to:
receive a task result from the task-target device; and
provide the task result to a task-source device.

18. The compute device of claim 10, wherein the task processing manager is configured to cause the compute device to:
receive a first task result from the task-target device that processes at least the portion of the task;
process a remainder portion of the task to produce a second task result; and
provide the first task result and the second task result to a task-source device.

19. A distributed system of devices, comprising:
a task-source device to generate a task processing request to process a task;
a task-target device to process at least a portion of the task; and
a compute device to:
receive, from the task-source device, the task processing request to process the task;
obtain a power availability state for each device in the distributed system of the devices;
obtain a thermal state for each of the devices in the distributed system of the devices;
select, based on at least one of the power availability state or the thermal state for each device, the task-target device from the distributed system of the devices; and
provide, to the task-target device, at least the portion of the task for processing by the task-target device.

20. The distributed system of the devices of claim 19, wherein the compute device is configured to receive a task result from the task-target device, and provide the task result to the task-source device.
